(19) United States
(12) Patent Application Publication
(10) Pub. No.: US 2023/0178268 A1
(43) Pub. Date: Jun. 8, 2023

(54) HVAC-cable with composite conductor

(71) Applicant: NEXANS, Courbevoie (FR)

(72) Inventors: Jonas LARSSON, FREDRIKSTAD (NO); Audun JOHANSON, OSLO (NO); Martin HOVDE, GRALUM (NO)

(21) Appl. No.: 17/960,686

(22) Filed: Oct. 5, 2022

(30) Foreign Application Priority Data
Oct. 11, 2021 (EP) 21306424.9

(51) Int. Cl. H01B 9/00; H01B 9/02; H01B 1/02; H01B 3/30; H01B 7/08; H01B 7/18; H01B 7/20; H01B 7/22

(52) U.S. Cl. CPC H01B 9/006; H01B 9/027; H01B 1/02; H01B 3/30; H01B 7/0876; H01B 7/1805; H01B 7/207; H01B 7/22

(57) ABSTRACT

A high voltage alternative current cable is provided having mechanically reinforced electric conductor, by having a reinforcement member at the centre of the conductors of the cable, where the reinforcement member is made of one or more low or non-magnetic steel wires, one or more wires of CuNiSi precipitation alloy, or one or more aluminium wires made of an EN AW-1xxx, EN AW-2xxx, EN AW-5xxx, AW-6xxx, EN AW-7xxx, or EN AW-8xxx alloy, according to the European aluminium standard.

### RELATED APPLICATION

This application claims the benefit of priority from European Patent Application No. 21 306 424.9, filed on Oct. 11, 2021, the entirety of which is incorporated by reference.

### FIELD OF THE INVENTION

The present invention relates to a high voltage alternative current cable having mechanically reinforced electric conductor.

### BACKGROUND AND PRIOR ART

Offshore maritime infrastructures such as e.g. floating wind power installations, offshore oil and gas extraction facilities etc., may be electrically connected to e.g. subsea installations on the seabed, floating installations, on-shore electricity grids etc. The transfer of electric power between offshore facilities and/or onshore grids/facilities often requires submarine power cables having relatively high mechanical strengths to endure stretching and/or compression forces acting on the cable, especially in cases where the installations are in areas with great water depths.

Power cables for intermediate to high current capacities have typically one or more electric conductors at its core followed by electric insulation and shielding of the conductors, an inner sheathing protecting the core, armouring layer, and an outer sheathing as shown schematically in FIG. 1. This embodiment comprises three electric conductors 12, each electrically insulated by an insulation 14. An inner sheathing 16 encompasses the three conductors, then follows an armouring 18 and an outer sheathing 19. These are the typical minimum of components required to make a functional power cable with comparably high electric power transferring capacity. In the case of submarine power cables, it is necessary to include a water barrier around each electric conductor and/or around the core of the cable. A power cable may however also comprise one or more additional components depending on the intended properties and functionalities of the power cable.

The conductors of power cables are typically made of either aluminium or copper. The conductor may either be monolithic, i.e. made of a single strand surrounded by electric insulating and shielding layers, or a plurality of strands arranged into a bunt being surrounded by electric insulating and shielding layers.

The armouring of high voltage alternative current (HVAC) cables are typically made of steel wires wound in one or more layers around the cable core containing the electrically insulated conductor(s).

However, the most commonly applied steel wires are made of ferritic steel which is magnetic. In a three-phase AC power cable, the fluctuating magnetic fields radiated by the three electric conductors causes hysteresis and eddy current losses. This magnetic loss may constitute up to about ⅓ of the total loss of electric energy in a power cable.

It is known from e.g. EP 2 812 457 that this magnetic loss may be significantly reduced by applying austenitic (non-magnetic) steel wires in the armouring layer of the cable.

EP 2 210 260 discloses an umbilical assembly for supplying power to subsea equipment which includes an electrical conductor to convey an electrical current to the subsea equipment. An insulator surrounds the conductor. A support member is positioned between the insulator and the conductor. The support member has either non-magnetic properties or low-magnetic properties because of its material composition. The support member is adapted to connect to a structure at the surface of the sea. The support member supports the weight of the conductor. The supporting of the weight of the conductor by the support member can be to reduce creep typically associated with the conductor supporting its own weight. The support member can be used to hermetically seal the conductor and prevent hydrogen migration along the conductor.

### OBJECTS AND SUMMARY

The main objective of the invention is to provide high voltage alternating current power cable having a composite electric conductor.

The present invention is the reduction to practice of the realisation that the necessary mechanical integrity and resilience of subsea power cables may be realised without an armouring layer around the cable core, as is commonly applied in prior art cables. Exclusion of the armouring layer around the cable core may yield large manufacturing cost savings. This is obtained by applying electric conductor(s) adapted to provide the mechanical strength and integrity of the power cable.

Thus, in a first aspect, the present invention relates to a power cable (1), comprising:
at least one conductor having a longitudinal centre axis and an outer sheathing encompassing the at least one conductor, wherein each of the at least one conductor comprises:
   a current conducting material (3), and
   an electric insulating material (4) enclosing the current conducting material (3), and

characterised in that
the at least one conductor further comprises a reinforcement member (2) located at the longitudinal centre axis of the conductor and where reinforcement member is embedded in and enclosed by the current conducting material (3), and where the reinforcement member is made of either:
   one or more steel wires,
   one or more wires of CuNiSi precipitation alloy, or
   one or more aluminium wires made of an EN AW-1xxx, EN AW-2xxx, EN AW-5xxx, AW-6xxx, EN AW-7xxx, or EN AW-8xxx alloy, according to the European aluminium standard.

The term “reinforcement member” as used herein encompasses any known or conceivable metallic member having a higher mechanical strength/resilience to axial tensions, and thus a higher yield limit, as compared to typical electric conducting materials applied in conductors. The metallic member may further be low or non-magnetic. Thus, the reinforcement member is a mechanical reinforcement of the conductor which enables forming power cables without the conventional armouring typically being laid around the cable core. Examples of suited materials for the reinforcement member includes, but is not limited to, low or non-magnetic steel, and/or mechanically resilient Al or Cu alloys such as a CuNiSi precipitation alloy, an EN AW-1xxx, EN AW-2xxx, EN AW-5xxx, AW-6xxx, EN AW-7xxx, or EN AW-8xxx alloy, according to the European aluminium standard. The reinforcement member may be a single strand wire, i.e. monolithic wire, or composed of a plurality of wires arranged in a bunt. The plurality of wires may be or may not be twined together.

The term “low or non-magnetic steel” as used herein encompasses any steel having magnetic properties comparable to duplex steel or lower, i.e. a magnetic volumetric susceptibility of χᵥ^{SI}<60. Thus, any austenitic steel or duplex steel may be applied in the reinforcement member. Examples of suited steels includes, but is not limited to; AL 4565 superaustenitic stainless steel (UNS 34565), AISI 304 Stainless Steel (UNS S30400), AISI 316 Stainless Steel (UNS S31600), duplex steel UNS S31803 (EN 1.4462), super-duplex steel UNS S32750 (EN 1.4410), or lean duplex steel UNS S32304 (EN 1.4362).

The term “current conducting material” as used herein, encompasses any metal or metal alloy known to the person skilled in the art having an electric conductivity making the metal/alloy suitable for conducting electric currents. In practice, the electrically conductive material being applied as conductor(s) in power cables may advantageously have an electric conductivity of at least 2.9·10⁷ S/m at 20° C., preferably of at least 5.0·10⁷ S/m at 20° C. and most preferably of at least 6·10⁷ S/m at 20° C. Examples of materials being suited as the current conducting material include, but are not limited to; Cu, Cu-alloy, Al, or an Al-alloy.

The term “conductor” as used herein comprises the current conducting material including an electric insulation around the current conducting material of one electric phase of the power cable. Thus, a one-phase power cable contains only one conductor, while a three-phase cable contains three conductors. In addition, the conductor(s) of the present invention comprises further a reinforcement member being embedded in the current conducting material to enhance the mechanical strength of the power cable. In one embodiment, the power cable according to the invention may comprise three conductors.

In the conductor(s) according to the present invention, the current conducting material encompasses and embeds the reinforcement member such that the current conducting material forms a shell/layer laid onto and covering the surface of the reinforcement member. The shell/layer of current conducting material may be a monolithic shell/layer laid radially around the reinforcement member or consist of a plurality of wires of the current conducting material surrounding the reinforcement member. The plurality of wires of the current conducting material may in one embodiment be twined together. In the latter case of applying a plurality of strands of current conducting materials, the space in-between the strands may be occupied by a semiconducting filler compound.

The above described composite structure of the conductor according to the invention, i.e. the reinforcement member at the centre and a layer of current conducting material, may be obtained in any manner known or conceivable to the skilled person. For example, in the case of a monolithic shell/layer of current conducting material, the shell/layer may be formed by wrapping a sheet of the current conducting material around the reinforcement member and seam welding the sheet to form a tube.

The term “electric insulating material” as used herein, encompasses any known or conceivable material, including dielectric materials, known to the skilled person as being suited as insulation of the current carrying conductor(s) of power cables. In practice the electric conductivity of the material being applied as insulation may advantageously have an electric conductivity of less than 10⁻¹⁴ S/m at 20° C., preferably less than 10⁻¹⁶ S/m at 20° C., preferably less than 10⁻¹⁸ S/m at 20° C., and most preferably less than 10⁻²⁰ S/m at 20° C. Examples of materials suited for being applied to form the electric insulation of the conductor(s) include, but are not limited to; ethylene propylene rubber (EPR), ethylene propylene diene monomer (EDPM), rubber, polyethylene (EP), polypropylene (PP), polyurethane (PUR), cross-linked polyethylene (XLPE), and mass-impregnated (MI) paper. The insulation effect of the insulating material depends on the thickness of the layer of insulating material. In general, the higher voltage of the electric current in the conductor, the more insulation is needed. The determination of amount of insulating material required to electrically insulate a conductor is within the ordinary skills of the person skilled in the art.

The conductor may in one embodiment further comprise a semiconducting conductor screen arranged radially around and encompassing the single strand or bunt of strands of the current conducting material. The term “semiconducting” as used herein, refers to the material having an electric conductivity intermediate between the conductivity of materials applied as electric conductors and materials applied as electric insulators. Examples of suited polymers for use as semiconducting conductor screen includes, but is not limited, to a polyethylene-based material constituted of either low density polyethylene (LDPE), a linear low density polyethylene (LLDPE), a medium density polyethylene (MDPE), or a high density polyethylene (HDPE), or a copolymer of ethylene with one or more polar monomers of; acrylic acid, methacrylic acid, glycidyl methacrylate, maleic acid, or maleic anhydride made semiconducting by addition and homogenisation of until 40 weight % particulate carbon in the polymer mass. Examples of suited particulate carbon includes but is not limited to; comminuted petrol coke, comminuted anthracite, comminuted char coal, carbon black, carbon nanotubes, etc.

The term “cable core” as applied herein refers to the electricity carrying part of the power cable. Thus, the cable core of the power cable according to the invention comprises at least the one or more hybrid conductors of the power cable, but may alternatively further comprise optical fibres, umbilical tubes, distancing profiles arranging the electric conductors in a circular cross-section and any other component known to be present in a cable core.

The electric conductors and their electric insulation may need protection towards intrusion of water/moisture. An ingress of moisture into the electricity carrying parts of the cable may lead to a failure of the cable. This is especially important for power cables applied in aqueous environments. Thus, in one embodiment, the at least one conductor(s) further comprises an inner sheathing/water barrier having excellent water barrier properties laid outside of the electric insulation of each of the one or more conductors to block any intrusion of water and/or moisture into the current carrying core of the conductor(s). Alternatively, the inner sheathing/water barrier may be applied around the cable core, i.e. the power cable comprises a single inner sheathing/water barrier protecting all components of the cable core. In the latter embodiment, the conductor(s) of the power cable has no inner sheathing/water barrier.

The inner sheathing/water barrier should endure any movements imposed on the power cable by wave motions, under water currents etc. without fatigue, unintended separation between the layers, cracking or any other mechanical breakdown destroying the water barrier function of the inner sheathing during the desired lifetime of the power cable, which may be many years. The inner sheathing may advantageously also function as an emergency earthing conductor leading eventual short circuit currents and/or eventual capacitive charging currents in the power cable to ground. I.e. there are rather stringent mechanical requirements imposed on the inner sheathing of power cables such that the inner sheathing is usually a metallic tube of sufficient diameter to house at least the electrically insulated conductor(s).

The invention is not tied to any inner sheathing/water barrier but may apply any sheathing/water barrier known to the person skilled in the art. Examples of suited inner sheathing/water barrier includes, but is not limited to, either:

a metal foil/layer of:
a) Al or an Al-alloy of an AA1xxx series, an AA5xxx series or an AA6xxx series alloy according to the Aluminium Association Standard,
b) Cu or a Cu-alloy, a CuNi-alloy, or a CuNiSi-alloy,
c) Fe or a Fe-alloy, a SS316 alloy or a S32750 alloy according to the ASTM A240/A240M-20a standard, or
d) Pb or a Pb-alloy,

or:

a laminate of a metal foil/layer of:
one of a), b), c) or d) and a polyethylene-based polymer chosen from one of; a low density polyethylene (LDPE), a linear low density polyethylene (LLDPE), a medium density polyethylene (MDPE), or a high density polyethylene (HDPE), or
a copolymer of ethylene with one or more polar monomers of; acrylic acid, methacrylic acid, glycidyl methacrylate, maleic acid, or maleic anhydride.

In one embodiment, the inner sheathing/water barrier may be a laminate of a metal foil/layer as specified above and a polymer, such as e.g. a polyethylene-based material constituted of either low density polyethylene (LDPE), a linear low density polyethylene (LLDPE), a medium density polyethylene (MDPE), or a high density polyethylene (HDPE), or a copolymer of ethylene with one or more polar monomers of; acrylic acid, methacrylic acid, glycidyl methacrylate, maleic acid, or maleic anhydride. The polymer may in one embodiment be made semiconducting by addition and homogenisation of 20 to 40 weight % particulate carbon in the polymer mass. Examples of suited particulate carbon includes but is not limited to; comminuted petrol coke, comminuted anthracite, comminuted char coal, carbon black, carbon nanotubes, etc.

Power cables without armouring are limited by the strength of the conductor material, which will limit the application of the cable. For example, armour-less subsea three phase power cables having high strength aluminium alloy conductors have a depth limitation of around 1000 m. The use of a reinforcement member in the conductor core increases the mechanical strength of the cable enabling its use in deeper waters. The mechanical reinforcement may, in one example embodiment of the power cable, be further increased by also comprising an armouring laid around the cable core. The term “cable core” as applied herein refers to the inner current conducting part of the cable which typically comprises the one or more conductors, but may also comprise any other component known to be applied in cable cores such as e.g. distance holders to keep the three conductors of a three-phase cable apart from each other, fibre-optic cables, screening, water barrier, etc.

The invention is not tied to any specific armouring but may apply any armouring known to the person skilled in the art. Examples of suited armouring includes galvanized steel wires, steel tape, braid, sheath or low loss armour etc. The armouring will, due to being metallic, also function as emergency earthing conductor. In embodiments with such armouring, the armouring comes in addition to and is not to be confused with the reinforcement member at the centre of each conductor.

The power cable according to the invention may in one embodiment further comprise a bedding, such as e.g. a swellable tape. The bedding is an intermediate layer between the inner sheathing and the armouring, which both typically are metallic, to avoid metal-to-metal contact and the potential mechanical and corrosive problems such contact may arise. The bedding may typically be made of fibrous materials such as e.g. jute or hessian tape. The invention may apply any known or conceivable material in the bedding known to the skilled person to be suited as bedding.

The term “outer sheathing” as applied herein, refers to the outermost sheathing/-protective layer of the power cable facing the environment. The power cable according to the invention is not tied to any specific outer sheathing, but may apply any outer sheathing known or conceivable to the person skilled in the art. Examples of suited materials include, but is not limited to, a thermoplastic or a thermosetting material such as e.g. polyvinyl chloride (PVC), or a chlorosulphanated polyethylene (CSP).

### BRIEF DESCRIPTION OF THE DRAWINGS

FIG. 1 is a drawing seen from the side of a typical prior art three-phase power cable.

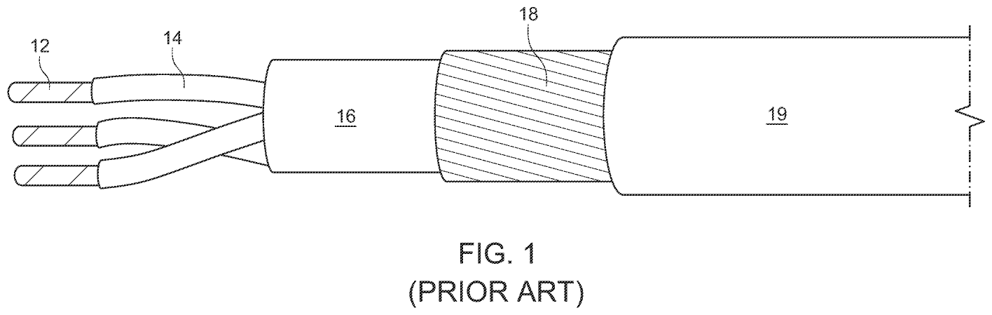

FIGS. 2a) and 2b) are drawings seen respectively from the side and front of a one-phase example embodiment of the power cable according to the invention.

FIGS. 3a) and 3b) are drawings seen respectively from the side and front of a one-phase example embodiment of the power cable according to the invention.

FIG. 4 is a drawing as seen from the front of an example embodiment of a three-phase power cable according to the invention.

### DETAILED DESCRIPTION

### First Example Embodiment

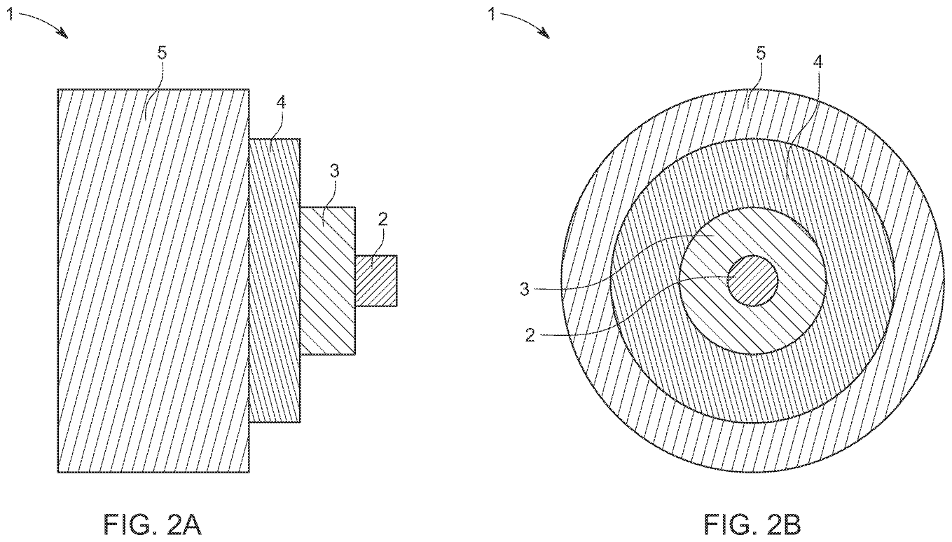

This example embodiment is a single phase power cable according to the first aspect of the invention which is schematically illustrated in FIGS. 2a) and 2b). FIG. 2a) is an exploded view of an end as seen from the side of the power cable and FIG. 2b) is a cut view as seen from the front.

The power cable 1 of this example embodiment has a reinforcement member 2 made of a bunt of austenitic steel wires of AISI 316 Stainless Steel (UNS S31600) at the centre. The steel wire is embedded in a layer 3 of aluminium wires of the AA1120 (UNS A91120) alloy constituting the electric conducting material. Then follows an electric insulation 4 of polyethylene (EP) and an outer sheathing 5 made of polyvinyl chloride (PVC). The cable core in this example embodiment consists of the reinforcement element 2, the electric conducting material 4 and the electric insulation 4.

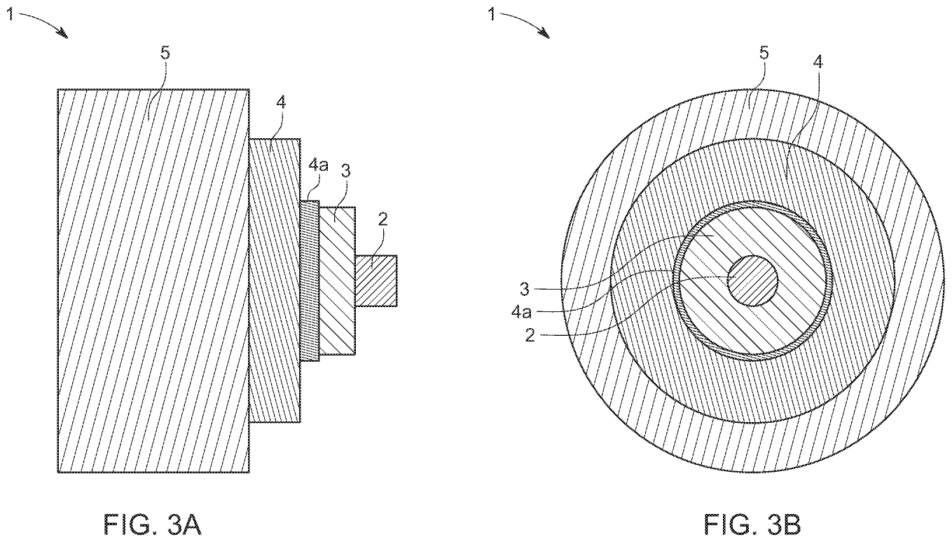

FIGS. 3a) and 3b) illustrate a similar embodiment with the position of semiconducting conductor screen 4a shown.

### Second Example Embodiment

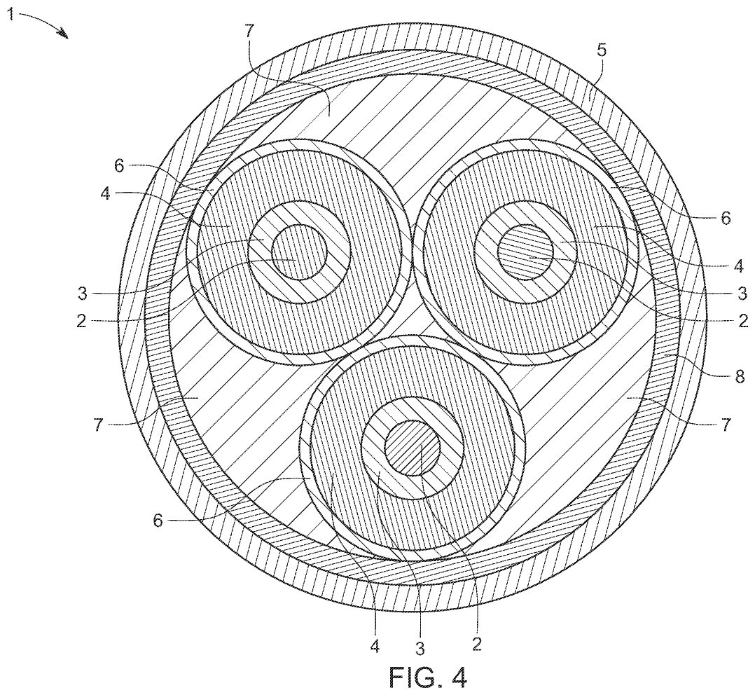

This example embodiment of the power cable according to the first aspect of the invention is a three-phase submarine power cable illustrated schematically in FIG. 4). The figure is a cut view as seen from the front.

The power cable 1 of this example embodiment has three conductors, each consisting of a reinforcement element 2 made of a bunt of austenitic steel wires of AISI 316 Stainless Steel (UNS S31600) at the centre followed by a layer of aluminium wires of the AA1120 (UNS A91120) alloy constituting the electric conducting material 3. Then follows an electric insulation layer 4 of polyethylene (EP). In contrast to the conductor of the first example embodiment, the conductors of the second example embodiment also consisted of an inner sheathing/water barrier 6 made of a CuNiSi-alloy having a composition of from 0.8 to 30 weight % Ni, from 0.1 to 2 weight % Si, from 0.1 to 1.5 weight % Fe, and from 0.1 to 1.5 weight % Mn, based on the total mass of the alloy. The three conductors are held in place by distancing profiles 7 providing the cable core (which in this example embodiment comprises the three conductors and the distancing profiles) with a circular cross-section.

Outside of the cable core, the cable of this example embodiment has an armouring 8 of galvanized steel wires and an outer sheathing 5 made of polyvinyl chloride

Verification of the Invention

Numerical calculations have been carried out on embodiments according to the invention and comparison embodiments of 245 kV three-phase power cables to investigate the power loss (AC resistance).

The calculations were made by applying a two-dimensional modelling based on the Finite Element Method (FEM). The calculations accounted for both skin and proximity effects. The comparison embodiments include cables having non-hybrid conductors and cables having hybrid conductors but with reinforcing element (the steel phase) lying on the outside of the conducting material, i.e. an inverse configuration as compared to the hybrid conductor according to the invention which has the reinforcing element at the centre of the conductor.

Common to all example embodiments applied in the calculations is that each conductor had a first 1.5 mm thick semiconductive sheath laid onto the outer metal phase (either the current conducting material or the reinforcement element, depending on which of them being outside of the other), then followed a 22 mm thick insulation layer of XLPE (cross-linked polyethylene), a second 1.5 mm thick semiconductive sheath, and then a 2.2 mm thick lead sheath as water barrier. The current conducting material in all example embodiments was an aluminium alloy AA1120 (UNS A91120) defined to have a resistivity of 2.89766·10⁻⁸ [Ohm-m] and a relative magnetic permeability of 1. The reinforcement element was either made of a carbon steel assumed to have a resistivity of 2.00·10⁻⁷ [Ohm-m] and a relative magnetic permeability of 700, or made of AISI 316 Stainless Steel (UNS S31600) assumed to have a resistivity of 7.40·10⁻⁷ [Ohm-m] and a relative magnetic permeability of 1. The carbon steel applied as comparison reinforcement element is a hypothetical carbon steel ally having electric and magnetic properties close to a G34-series carbon steel and is thus denote as G34 in table 1. In the model the cores are set to carry balanced three-phase current of 1000 A at 50 Hz. Upon solving the FEM-model, the current distribution between inner core material and the conductor material is determined. A conductor temperature of 90° C. is assumed.

Both the current conducting material and the reinforcing element in these example embodiments consisted of wires stranded together, the different configurations of the hybrid conductors applied in the calculations are summarized and the calculated AC resistivities are given in table 1:

TABLE 1
Configuration of wires in the conductors applied in the calculations

| | | | | | | | Calculated |
|---|---|---|---|---|---|---|---|
| Inner wires | | | | Outer wires | | | AC |
| | | Diam. | # of | | Diam. | # of | resistivity |
| | Material | [mm] | wires | Material | [mm] | wires | [Ohm/km] |
| Case 1 | 1120¹⁾ | 4.10 | 91 | — | — | — | 0.0348 |
| Case 2 | G34²⁾ | 4.10 | 19 | 1120 | 4.10 | 72 | 0.04104 |
| Case 3 | SS316³⁾ | 4.10 | 19 | 1120 | 4.10 | 72 | 0.04077 |
| Case 4 | G34 | 2.08 | 62 | 1120 | 3.68 | 113 | 0.03348 |
| Case 5 | SS316 | 2.08 | 62 | 1120 | 3.68 | 113 | 0.03332 |
| Case 6 | 1120 | 4.10 | 19 | G34 | 4.10 | 72 | 0.04719 |
| Case 7 | 1120 | 4.10 | 19 | SS316 | 4.10 | 72 | 0.04169 |
| Case 8 | 1120 | 2.08 | 62 | G34 | 3.68 | 113 | 0.03768 |
| Case 9 | 1120 | 2.08 | 62 | SS316 | 3.68 | 113 | 0.03430 |

¹⁾ASTM AA1120 aluminium alloy (UNS A91120)
²⁾Carbon steel close to G34 series
³⁾ASTM SS316 stainless steel (UNS S31600)

A comparison between the calculated AC resistances of case 1 of table 1 (a three-phase power cable having non-hybrid conductors of only aluminium AA1120 wires) and cases 4 and 5, shows that a hybrid conductor having the reinforcement element located at the centre of the conductors may attain a power loss being equal or somewhat less than the power loss of a pure aluminium conductor.

Table 1 informs further that otherwise equal configurations except for applying a magnetic or a low or non-magnetic steel as the reinforcing element, typically gives a difference in the AC resistivities of 0.4 to 0.6%. For example, the AC resistivity when applying a reinforcing element of SS316 (case 3) at the centre of the conductor is 0.49 percent less than the AC resistivity when applying a reinforcing element of carbon steel (case2). A similar result of 0.65% reduction in the AC resistivity when applying SS316 steel is obtained between cases 4 and 5. This verifies that there is somewhat less power loss when applying a low-magnetic or non-magnetic steel in the reinforcing element of the hybrid conductor according to the invention. Even though these figures may seem small, the accumulated power losses over the lifetime of the cable becomes considerable. A similar reduction of 0.5-0.6% in the AC resistivity is also observed for the “inverted” cases (the comparison example with the reinforcement element outside the current conducting aluminium wires).

A significantly larger difference between the AC resistivities (and thus the power loss) is observed when comparing the hybrid conductor according to the invention having the reinforcement element at the centre of the conductor with an “inverse” configuration where the current conducting wires are at the centre and the reinforcement element is laid onto the current conducting wires. The difference between the AC resistivities of e.g. cases 3 and 7, i.e. with SS316 steel at the core or on the outside is 2.25% when the steel is at the core. A comparison between cases 5 and 9 gives 2.9% reduction is the SS316 steel is located at the centre.

The results above show that there is a significant reduction in the power loss of three-phase power cables obtained by applying a reinforcing element of low magnetic or non-magnetic steel and locating it at the centre of the conductors.

1. A power cable comprising:
at least one conductor having a longitudinal centre axis and an outer sheathing encompassing the at least one conductor, wherein each of the at least one conductor comprises:
a current conducting material, and
an electric insulating material enclosing the current conducting material, and
wherein
the at least one conductor further comprises a reinforcement member located at the longitudinal centre axis of the conductor and where reinforcement member is embedded in and enclosed by the current conducting material, and where the reinforcement member is made of either:
one or more steel wires,
one or more wires of CuNiSi precipitation alloy, or
one or more aluminium wires made of an EN AW-1xxx, EN AW-2xxx, EN AW-5xxx, AW-6xxx, EN AW-7xxx, or EN AW-8xxx alloy, according to the European aluminium standard.

2. The power cable according to claim 1, wherein the power cable comprises three conductors.

3. The power cable according to claim 1, wherein the reinforcement member is made of a low or non-magnetic steel.

4. The power cable according to claim 3, wherein the low or non-magnetic steel is chosen from one of; an austenitic steel or a duplex steel, preferably one of AL 4565 superaustenitic stainless steel (UNS 34565), AISI 304 Stainless Steel (UNS S30400), AISI 316 Stainless Steel (UNS S31600), duplex steel UNS S31803 (EN 1.4462), super-duplex steel UNS S32750 (EN 1.4410), or lean duplex steel UNS S32304 (EN 1.4362).

5. The power cable according to claim 1, wherein the reinforcement member is either a single monolithic wire or is composed of a plurality of twined or not twined wires arranged in a bunt.

6. The power cable according to claim 1, wherein the current conducting material is a metal or metal alloy having an electric conductivity of at least 2.9·10⁷ S/m at 20° C., preferably of at least 5.0·10⁷ S/m at 20° C. and most preferably of at least 6·10⁷ S/m at 20° C.

7. The power cable according to claim 6, wherein the current conducting material is one of: Cu, Cu-alloy, Al, or an Al-alloy.

8. The power cable according to claim 6, wherein the current conducting material is a monolithic shell/layer laid radially around the reinforcement member or is made of a plurality of wires of the current conducting material surrounding the reinforcement member.

9. The power cable according to claim 1, where the electric insulation material is made of one of; ethylene propylene rubber (EPR), ethylene propylene diene monomer (EDPM), rubber, polyethylene (EP), polypropylene (PP), polyurethane (PUR), cross-linked polyethylene (XLPE), or mass-impregnated (MI) paper.

10. The power cable according to claim 1, where the power cable further comprises a semiconducting conductor screen arranged radially around the current conducting material, and where the semiconducting conductor screen is made of a polyethylene-based material constituted of either low density polyethylene (LDPE), a linear low density polyethylene (LLDPE), a medium density polyethylene (MDPE), or a high density polyethylene (HDPE), or a copolymer of ethylene with one or more polar monomers of; acrylic acid, methacrylic acid, glycidyl methacrylate, maleic acid, or maleic anhydride made semiconducting by addition and homogenisation of until 40 weight % particulate carbon in the polymer mass.

11. The power cable according to claim 1, where the power cable further comprises an inner sheathing laid either as an outermost layer of each conductor of the cable or laid around a cable core, and wherein the inner sheathing is made of either
a metal foil/layer of:
a) Al or an Al-alloy of an AA1xxx series, an AA5xxx series or an AA6xxx series alloy according to the Aluminium Association Standard,
b) Cu or a Cu-alloy, a CuNi-alloy, or a CuNiSi-alloy,
c) Fe or a Fe-alloy, a SS316 alloy or a S32750 alloy according to the ASTM A240/A240M-20a standard, or
d) Pb or a Pb-alloy,
or
a laminate of a metal foil/layer of:
one of a), b), c) or d) and a polyethylene-based polymer chosen from one of; a low density polyethylene (LDPE), a linear low density polyethylene (LLDPE), a medium density polyethylene (MDPE), or a high density polyethylene (HDPE), or
a copolymer of ethylene with one or more polar monomers of; acrylic acid, methacrylic acid, glycidyl methacrylate, maleic acid, or maleic anhydride.

12. The power cable according to claim 1, where the power cable further comprises an armouring laid around a cable core.

13. The power cable according to claim 12, where the armouring is one of: galvanized steel wires, steel tape, braid, sheath, or low loss armour.

14. The power cable according to claim 1, where the outer sheathing is made of a thermoplastic or a thermosetting material chosen from a polyvinyl chloride (PVC) or a chlorosulphanated polyethylene (CSP).
